(19) United States
(12) Patent Application Publication
(10) Pub. No.: US 2007/0228675 A1
(43) Pub. Date: Oct. 4, 2007

(54) Vehicle with a main body having a longitudinal axis and with a tilting unit

(76) Inventors: Andrea Tonoli, Avigliana (IT); Andrea Festini, Collegno (IT); Fabio Cavalli, Alessandria (IT); Stefano Carabelli, Cesana Torinese (IT); Marcello Chiaberge, Collegno (Torino) (IT)

Correspondence Address: PAUL A. FATTIBENE;FATTIBENE & FATTIBENE, 2480 POST ROAD, SOUTHPORT, CT, 06890, US

(21) Appl. No.: 11/712,318

(22) Filed: Feb. 28, 2007

(30) Foreign Application Priority Data
Mar. 1, 2006 (EP) 06004159.7

(51) Int. Cl. B60G 17/015

(52) U.S. Cl. 280/5.506

(57) ABSTRACT

The invention concerns a vehicle with a main body having a longitudinal axis, and with a tilting unit for tilting the main body relative to a vertical plane through the longitudinal axis, whereby the tilting unit comprises an actuator, an control unit and a power provision unit for providing a power transmitting medium via the control unit to the actuator, whereby the control unit is configured to control the power intake of the actuator, characterized in comprising at least two redundant tilting units.

### FIELD OF THE PRESENT INVENTION

The present invention relates to the field of vehicles with a tilting unit. In particular, the present invention relates to a vehicle with a main body having a longitudinal axis, and with a tilting unit for tilting the main body relative to a vertical plane through the longitudinal axis, whereby the tilting unit comprises an actuator, a control unit and a power provision unit for providing a power transmitting medium via the control unit to the actuator, whereby the control unit is configured to control the power intake of the actuator.

### DESCRIPTION OF THE PRIOR ART

Vehicles being able to tilt, are known from the prior art. In such vehicles, the tilting can be commanded by the driver directly or by actuators, such as hydraulic actuators. Those vehicles with actuators can be classified into two categories, namely, vehicles with manual tilting and vehicles with tilting units. Vehicles with manual tilting, where the command to the suspension system is provided only by the driver, are disclosed in published patent applications WO 2004/011324 A1, (corresponding to US 2006 0097471) WO 2005/002957 A1 and WO 99/41136 A1. In those vehicles the driver can control the direct tilting of the vehicle with a footbar or by the position of his body.

WO 2004/011324 A1, an International Application published under the Patent Corporation Treaty, discloses a vehicle with at least three wheels, with a first frame part, also explained as a main body that is provided with at least two foot boards, and a second frame part. The second frame part is connected to the first frame part in such a way that it can tilt about a tilting axis running in a longitudinal direction, whereby the second frame part comprises a control element and a driver's seat. The tilting unit is connected to the main body and the second frame part, in order to exert a tilting force on the second frame part from a control signal. A sensor is connected to the first frame part, for the purpose of measuring a force or a moment exerted by a driver on the main body and/or to determine the position of the rider relative to the footboard, whereby the sensor is connected on the other hand to the tilting unit and feeds the control signal to the tilting unit. As a tilting unit, a hydraulic cylinder is disclosed.

The International Patent Application published under the Patent Corporation Treaty, WO 2005/002957 A1 discloses a three-wheeled vehicle comprising a frame with an engine, a drive gear and at least one driven wheel at the rear, and two front wheels, which are used in part to steer the vehicle. A transfer frame in the longitudinal direction of the vehicle having a perpendicular frame member is also disclosed therein, as well as spring anchors provided on the frame member for mounting springs.

The International Patent Application WO 99/41136 A1 discloses another three-wheeled vehicle, with a frame capable of inclining when handling a curve. The frame therein has two steering front wheels and one rear wheel comprising a rigid portion and a trapezoidal portion capable of being deformed and in line with the center of gravity of the vehicle and the loads applied therein to be shifted to the inside of the curve which is being negotiated, whereby the steering is controlled by a suitable linkage and a handle bar, and the side inclination is controlled by the driver by shifting his body.

Vehicles where the tilting is controlled by a servo system are disclosed, for example, in the European Patent Application EP 0 020 835 A1. Therein, an ultra narrow enclosed motor vehicle is disclosed. This vehicle has a chassis supported by road running wheels which include a main section pivotally connected to a sub-section whereby pivotal movement can take place between the two sections along a pivotal axis extending in the longitudinal direction of the vehicle. A closed-in body structure mounted on one of the chassis sections provides accommodation for at least one person. A drive means for the vehicle is mounted on the other one of the chassis sections. Control means are provided in this vehicle for enabling variable selection of the amount and sense of relative pivotal movement between the two chassis sections. A motor drive and hydraulic pump are coupled with a valve arrangement. Also pneumatic or electromagnetic coupling means connected to a tilting mechanism are disclosed.

The suspension control system for leaning a vehicle is disclosed in WO 99/47372, also being a published International Patent Application. A roll angle control is disclosed as being achieved by selectively causing or preventing changes in a diagonal dimension of a parallelogram. A necessary damping is achieved through a linear hydraulic damper unit placed so, as to resist changes in flexure of a transverse beam spring while allowing roll freedom. The roll angle is disclosed as being controlled either via bicycle-like maneuvering, by an operator, by a device as to selectively control a diagonal dimension as a parallelogram, or via a combination of both.

An unguided vehicle capable of inclination when taking a corner is disclosed in International Patent Application WO 99/12795 A1. An active road control is disclosed therein as well.

In the case of vehicles, where the commands are generated by a control system, in the state of the art a control system is known that sends commands to the hydraulic or electric actuators to drive the tilting of the vehicle. Such a control system bases its command output from the information sent by sensors and from driver commands. All of the above described vehicles have a major drawback, namely, if one unit fails, the whole system fails and the vehicle cannot be controlled. This can lead to fatal accidents. If the tilting system with the tilting unit fails, a driver moving his vehicle into a corner, whereby normally the vehicle would tilt, will now not tilt. This changes the dynamic properties of the vehicle considerably. In many cases this will lead to an accident, as the driver will unexpectedly not be able to control his vehicle during cornering of the vehicle.

The International Patent Application WO 98/49023 A1 (corresponding to U.S. Pat. No. 6,250,649) discloses a multi-track curve tilting vehicle. This vehicle comprises a control system for tilting a super-structure. The control system comprises an emergency back-up system which enables the vehicle to operate for at least a given period of time, if the normally effected main system fails or breaks down. Three super-structure positions are possible depending upon the lateral acceleration of the vehicle, that is, maximum left tilt, upright position, and maximum right tilt. The emergency back up system is controlled by means of inertia mass.

However, this emergency back-up system uses hydraulic fluids which have the drawback of being inflammable. They also have the drawback that any leak in the lines or conduits of the hydraulic fluid lead to a total failure of the tilting system, and even the emergency back up system.

The hydraulic back up system of WO 98/49023 A1 has the purpose of guaranteeing the safety of the tilting vehicle when the tilting actuators cannot work due to failure. Only the failure of a single actuator can be compensated for.

Therefore, there is a need for a tilting vehicle that safer and that will not fail during critical cornering so as to prevent a driver from loosing control and inuring potentially fatal injuries.

### SUMMARY OF THE INVENTION

It is therefore an object of the invention to avoid such unstable dynamical properties of the vehicle, to avoid accidents, especially fatal accidents.

It is therefore an object to provide a safe vehicle that is safely controlled by a driver, even if the whole tilting unit fails thereby avoiding the loss of control of the vehicle during cornering in a curve.

According to the present invention, a solution for the above identified objects and problems are achieved for a vehicle by comprising at least two redundant tilting units.

The invention relates to an electric servo system to drive a suspension system in a tilting vehicle with redundancy characteristics. By providing two redundant tilting units as a hot or simultaneously active redundant system, it is possible that one tilting unit provides the necessary tilting through a corner, even if one tilting unit breaks down while in the corner. As the tilting units each comprise a control unit, a power provision unit and an actuator, two discreet and independent circuits are available to provide tilting power and tilting movement during cornering. By hot redundant system, two chains of tilting unit components are to be understood, which work together or are simultaneously active in normal operation to produce the necessary tilting torque.

Even if a failure happens in one circuitry or chain, the other circuitry or chain, consisting of one tilting unit each, can independently bring the necessary tilting movement to the main body so to maintain control and prevent an accident from happening. The driver can always control his vehicle, as the dynamic properties of the vehicle do not change abruptly.

There are further solutions and special embodiments which are described below.

It is especially favorable if the tilting unit is an electrical device, preferably exclusively an electronic device. Loss of the power transmitting medium is avoided and a fire hazard during a crash due to inflammable hydraulic fluid, which is normally oil, is also minimized. The environmental impact of the vehicle is also improved.

It is especially preferable, if an actuator being configured as an electronic unit, such as an electromotor, is comprised in one or each tilting unit. Electromotors are inexpensive, reliable elements, without the need to use hydraulic fluid which is oil.

If the control unit comprises a power electric unit and/or an electric circuit unit, the electric circuit unit can trigger the power electric unit and, depending upon the situation or configuration, the vehicle can provide the power transmitting medium to the actuator, especially the electromotor.

It is desirable to have the possibility to independently provide energy via the power transmitting medium to each tilting unit. In another embodiment, the power provision unit may include electric power storage, and/or a mechanical energy converter. If the electrical power storage comprises a battery, power can be easily stored and provided to the actuator via the control unit.

In the case of failure of a battery it is preferable that another embodiment includes a mechanical energy converter, comprising a high voltage AC generator and an AC/DC converter.

In another preferred embodiment, a mechanical energy converter further comprises a controller for monitoring the status and charge condition of the battery so that depending on the charge condition and status of the battery, the battery can be charged through the controller in combination with the high voltage AC generator and the AC/DC converter. Power can then also be independently applied to either one of the control units or either one of the actuators. If the electric power storage and the mechanical energy converter of one of the tilting units is also connected to the controller of the other tilting unit in this embodiment, a selective powering of each actuator is possible.

It is preferable, in another embodiment, that the power transmitting medium is electricity or an electric current, so that no flammable power medium is necessary. An electric current is also easy to provide in a vehicle.

In another preferred embodiment, the controller is configured to uncouple the battery from either of the two control units and supply electricity to either of the two control units from the AC/DC converter and a generator.

To give the driver feedback or information on the condition of the vehicle, it is also desirable that the vehicle includes a signaling element or information display. The control units, especially the electric circuit units, of the two tilting units are configured to communicate with each other to assure the functionality of at least one of the two tilting devices, so that they can automatically or manually switch to powering either one of the actuators and the tilting units.

The driver can take preventive action if the signaling element is coupled to at least one electric circuit, preferably both, to provide the driver with a signal if the vehicle malfunctions. One or two tilting units may be used, in this preferred embodiment.

In another preferred embodiment, the vehicle includes a transducer coupled between the tilting units and the main body. Regulations and laws in different countries do not impose a redundancy for mechanical parts, but only test their reliability. In a wire tilting servo system there is a great necessity to have redundant systems. For bringing the right amount of power to the main body, it is preferable that a transducer transmits the right amount of movement to the main body of the vehicle.

As mechanical parts are, in general, more reliable than electrical parts, and the laws in different countries do not impose the need to have redundant mechanical parts, it is preferable, if only one single transducer, such as a reduction gear, is coupled between the two tilting units on the one side and the main body on the other side, to minimize the weight and costs of the vehicle.

If the transducer comprises a mechanical element, such as a steering shaft or a brake caliper, standard mechanical elements, which are easy to provide and are inexpensive, can be used.

In another preferred embodiment, the vehicle comprises a first mode switch to choose between a manual or an automatic tilting mode. This feature is preferable, to improve the driving feeling and the safety of the vehicle.

In another preferred embodiment, the vehicle includes a second mode switch to select the acceleration and/or speed of the tilting unit tilting the vehicle permitting the performance of the tilting unit to be easily changed. Therefore, rapid tilting actuation, such as necessary in sport driving, can be obtained. Also a smooth actuation, such as preferred in normal driving, is also easily realizable.

A rapid tilting actuation can be obtained by a high torque provided by the electromotor or a smooth actuation realized by limiting the motor torque. It is therefore preferable in another embodiment, if the second mode switch is configured to change the torque of the actuator, especially the electromotor.

In another preferred embodiment, the vehicle comprises at least one sensor, such as the current sensor, an accelerometer and/or a position sensor, to deliver data concerning the actual state of the vehicle to one of the control units, preferably especially one of the electric circuit units. Thereby in the automatic mode, achieved by switching the first mode switch to the automatic motor, a precise tilting movement can be achieved. If the sensor is coupled to both electric circuit units, even in the failure of one tilting unit, a highly precise tilting movement can be achieved.

To make an override command for the driver possible, it is preferred in another embodiment that, the electric circuit unit is configured as an open loop control. If the electric circuit unit is configured as a closed loop control, then the electric circuit unit, also known as an ECU, can conduct the necessary changes and tilt the main body of the vehicle by itself, without explicit instructions by the driver.

A combination is realized in another preferred embodiment, wherein both electric circuit units are configured as an open loop control or a closed loop control. During a failure of one tilting unit, a change from a manual control modus to an automatic control modus can be realized.

If the tilting unit comprises a recharge unit, configured to recharge the power provision unit, further security is achieved in another additional preferred embodiment.

Another preferred embodiment consists in shunting the electrical connection of the electric motors with a tunable resistance. This mode of operation can be indicated as “passive” as the tilting actuator does not require any external power from the vehicle. Its mechanical output becomes that of a damper that counteracts the titling of the vehicle. This is due to the fact that permanent magnets electric motors can be used as electric generators.

If the electrical terminals of this type of motors are shunted by a resistance the power dissipated in the resistance corresponds to a drag torque to the shaft of the motor. The smaller the shunt resistance is the larger the damping action. In this mode of operation the task of controlling the stability of the vehicle must be provided by the driver by acting on the steering or by moving its center of gravity relative to the vehicle. The shunt resistance may be realized by a resistor or by the same control units used to drive the motors in the “active” mode.

The possibility of a “passive” mode improves the safety of the vehicle, as it guarantees the functionality even in the case, when no power can be provided to the control units. The minimum amount of electrical power necessary to maintain the operation of the control units may be obtained from the same electric motors that operate in the “passive” mode.

### BRIEF DESCRIPTION OF THE DRAWINGS

In the following, a description will be given with reference to the drawings of particular and/or preferred embodiments of the present invention.

It has, however, to be noted that the present invention is not limited to the embodiments disclosed, but that the embodiments disclosed relate to particular examples of the present invention, the scope of which is defined by the claims The drawings show in particular:

FIG. 1 is a schematic circuit diagram showing a first embodiment with a transducer and two tilting units, which each include a battery; and

FIG. 2 is another schematic circuit diagram of a second embodiment with one transducer, such as a mechanical reduction gear, two redundant tilting units, whereby the actuators therein are selectively powered by a battery or a mechanical energy converter, and also comprise a generator, a converter and a control unit.

### DETAILED DESCRIPTION OF THE PREFERRED EMBODIMENTS

While the present invention is described with reference to the embodiments as illustrated in the following detailed description, as well as in the drawings, it should be understood that the following detailed description, as well as the drawings, are not intended to limit the present invention to the particular illustrative embodiments disclosed, but rather that the descriptive illustrative embodiments merely exemplify the various aspects of the present invention, the scope of which is defined by the claims.

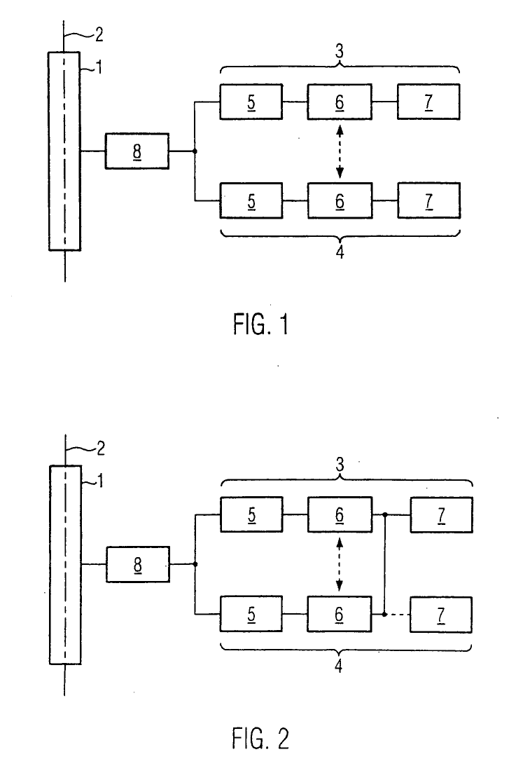

FIG. 1 shows a part of a vehicle having a main body 1. This main body 1 has a longitudinal axis 2. The main body 1 of the vehicle can tilt around the longitudinal axis. An angle between a vertical plane through a longitudinal axis and a horizontal plane changes during the tilting action. The necessary force for the movement of the main body 1 is applied by one tilting unit 3 and one tilting unit 4. Each tilting unit 3 and 4 comprises an actuator 5, a control unit 6 and a power provision unit 7. In the embodiment of FIG. 1, the actuator 5 is an electromotor. The control unit 6 comprises a power electronic unit and an electric circuit unit. The two control units 6 of the two tilting units 3 and 4 are wired to each other, so that information can be transmitted from one control unit 6 to the other control unit 6. A wiring is configured between the two electric circuit units of the control unit 6.

In the embodiment of FIG. 1, the power is supplied by the power provision unit 7, namely a battery of each tilting unit 3 and 4.

Electric power is conducted from the battery, of the power provision unit, to the electric circuit unit of the control unit 6, then to the power electronic unit and then to the actuator 5, so that the actuator 5 of each tilting unit 3 and 4 is moved. The power provision unit 7 is therefore in the embodiment shown in FIG. 1, an electric power storage.

As information between the two electric circuit units of the control unit 6 is exchanged, malfunction of either of the tilting units 3 or 4 is detectable and when this malfunction is detected, this event is brought to the immediate attention of the driver via electric cables or wires and a display device.

During malfunction, the non-malfunctioning actuator 5 of the not malfunctioning tilting unit 3 or 4 provides the necessary power for moving the main body 1 via a transducer 8. The transducer 8 is configured as a mechanical gear, such as a reduction gear. Each actuator 5 is coupled to the one transducer 8. The actuator 5 in each tilting unit 3 or 4 is configured as an electromotor. The electromotor of the actuator 5 therefore moves a reduction gear, so that tilting of the main body 1 is achieved.

In FIG. 2, another embodiment of the current invention is shown. For the same elements, the same reference numbers are used. Different to FIG. 1 and the embodiment therein, the power provision unit 7 in the first tilting unit 3 is a battery, as conventional and also used in the embodiment shown in FIG. 1, whereas the power provision unit 7 of the other tilting unit 4 is a mechanical energy converter. This mechanical energy converter consists of a generator, an AC/DC converter and a controller. A generator is a high voltage AC generator. The mechanical energy converter is attached to either control unit 6 of the tilting unit 3 and the tilting unit 4. The battery of the power provision unit 7 of the first tilting unit 3 is also connected to the tilting unit 4, especially to the control unit 6 in each of the tilting units 3 or 4.

In both embodiments, the power provision units 7 are connected to the power electronic unit of the control unit 6.

In both embodiments, shown as FIG. 1 and FIG. 2, communication between the electronic circuit unit or ECU's of the control units 6 exists and is necessary to bring any malfunction to the attention of the driver and switch from one tilting unit 3 to the other tilting unit 4.

In the embodiment of FIG. 2, the controller of the mechanical energy converter of the power provision unit 7 monitors the status and the charge status of the battery of the other of the tilting units 3 or 4. When the controller gets the information that the battery is failing or the charge is getting low, or even too low in the battery, the necessary energy is transmitted via the high voltage AC generator to the AC/DC converter, and then to either of the electric circuit units of control units 6 in tilting unit 3 and tilting unit 4. Therefore, both actuators 5, namely both electromotors, are powered and get the necessary energy to move, via the transducer 8, the main body 1 of the vehicle around the longitudinal axis 2.

In these solutions, there are two actuators 5 to drive the tilting and the concept of redundancy on the tilting actuators 5 is provided. This concept is most important to assure the safety of the driver and the passenger in any vehicles where a by-wire system is present. If there is a failure in the control system or in the actuator, the tilting system can now work and the driver cannot lose control of the vehicle on a turn or curve. This system is operative when the principal system does not work and it is a hot redundant system. Thereby, the wire-tilting servo system combines the tilting units 3 and 4 with the transducer 8, using the electromotors driven by an electronic control unit, and has good properties.

The performance of the tilting mechanism, concerning acceleration and speed, can be easily changed by the torque of the electromotor. A rapid tilting actuation, which is necessary in sports driving, can be obtained with high torque provided by the electromotor or a smooth actuation, necessary for normal driving, is realized by limiting the motor torque. Therefore, the driver can choose the desired tilting behavior of the vehicle. Moreover, the ECU implements a closed loop control of the tilting, based on the measures of sensors, such as current sensors, accelerometers, and/or position sensors. It can also drive the motors based only on the driver commands, such as it is achieved by an open loop control. Therefore, the driver can choose, with a selector, the possibility of an automatic tilting control or a manual control. This feature is important to improve the driving feeling and the safety of the vehicle.

The electromotors are linked and parallel to a reduction gear that provides the torque to activate the tilting mechanism. When the system operates under normal conditions the electromotors work together to provide torque to the reduction gear. If a failure occurs in an electromotor, the second can provide torque to activate tilting. A redundancy of power supply and of control units is achieved, so that the system is fault tolerant. The two power electronic units, which are two electronic circuit units and two batteries, are included. In case of failure of one of these elements, the second chain assures the presence of torque on the reduction gear for providing safe driving and tilting. The tilting servo system is fault tolerant and has hot redundant characteristics, that is with normal operation to work together to produce the required tilting torque, defined as hot redundancy, and, in case of failure, one chain assures a safety torque on the tilting mechanism, so that it is fault tolerant. An important characteristic of the servo system, including the tilting units 3 and 4 and the transducer 8, consists of the communication between the ECU's, represented in FIGS. 1 and 2 by a dotted arrow between the two control units 6. In case of failure in the upper chain, namely the tilting unit 3, the ECU of control unit 6 of tilting unit 3 informs the ECU of the other control unit 6 of the other tilting unit 4 of the malfunctioning or vice versa. Therefore, the lower chain assures the functionality of the tilting mechanism and the ECU of control unit 6 informs the driver of the presence of a failure in the system. The performance of the tilting with only one active chain may be reduced, but it assures safe driving of the vehicle and the drive can safely control the vehicle.

The only part of the described system which is not redundant is the reduction gear. This element is a mechanical element, such as a steering shaft or a brake caliper. The laws in different countries do not impose a necessity to have a redundancy concerning mechanical parts. For this reason, in the by-wire tilting servo system, only a single reduction gear is included. However, two different forms of a transducer 8 would also be possible.

The second embodiment, shown in FIG. 2, has the further advantage of minimizing the weight of the vehicle, as the batteries are very heavy. One of the batteries can be replaced by the mechanical energy converter in one of the power provision units 7. In this embodiment, a high voltage AC generator is linked to a crank shaft of an internal combustion engine of the vehicle and an AC/DC converter. This converter must be driven by a control unit that monitors the status and the charge of the battery. This alternative solution has the redundant characteristics necessary to provide the solution for the problems discussed above. If a failure is present in the battery, it can be detected by the controller, which can react by excluding the battery and using the generator to directly supply the electromotors with power instead. In this case, the efficiency of the power supply is lower than the first embodiment, but it represents a back-up without using a second battery. The weight is lower than the first embodiment, at the cost of a greater complexity because an intelligent battery recharge must be implemented.

Another embodiment to further improve the safety of the vehicle is possible in the case the electric motors use permanent magnets. In this case they can work as generators and transform mechanical power into electrical power. If their electric terminals are connected to a resistive network the electric power is dissipated. The result is that a torque is needed to rotate the shaft of the electric motors. The resistive network can be either realized by resistors or by the same control unit that can synthesize a variable resistive load.

In this mode of operation, said “passive” mode, the tilting mechanism does not impose a tilting force on the vehicle, but it operates as a tilting damper and may improve the vehicle stability. In the “passive” mode the tilting is actuated by the driver by means of the steer action or by its lateral displacement on the vehicle.

No electrical power is required to the vehicle system, as the tilting actuator is operated in the “passive” mode. This guarantees the functionality of the vehicle even if no electrical power can be provided to the control units. The minimum amount of energy required to operate the control units may be provided by the same motors, used as generators.

By acting on the value of the shunt resistance the driver or the vehicle control unit can modify the amount of damping generated by the tilting actuator.

The invention has the advantage that no hydraulic fluid is necessary, and only electric actuators, such as electromotors can be used. This permits a better environmental impact of the vehicle. Also fault tolerant characteristics and a hot redundant system with two electromotors, which are working in parallel, are provided. In case of failure, the safety of the vehicle is assured. The possibility to choose an open loop or a closed loop control of the tilting of the vehicle is possible. This improves the driving feeling of the vehicle for any driver.

While the present invention has been described with respect to several different embodiments, it will be obvious that various modifications may be made without departing from the spirit and scope of the invention.

What is claimed is:

1. A vehicle with a main body (1) having a longitudinal axis (2), and with a tilting unit (3, 4) for tilting the main body (1) relative to a vertical plain through the longitudinal axis (2), whereby the tilting unit (3, 4) comprises an actuator (5), a control unit (6) and a power provision unit (7) for providing a power transmitting medium via the control unit (6) to the actuator (5), whereby the control unit (6) is configured to control the power intake of the actuator (5), comprising:
at least two redundant tilting units (3, 4).

2. The vehicle according to claim 1, wherein:
the at least two redundant tilting unit are an electronic device.

3. The vehicle according to claim 1, wherein:
the actuator comprises an electronic unit, such as an electromotor.

4. The vehicle according to claim 1, wherein:
the control unit comprises a power electric unit or an electric circuit unit (ECU).

5. The vehicle according to claim 1, wherein:
the power provision unit comprises an electric power storage and/or a mechanical energy converter.

6. The vehicle according to claim 5, wherein:
the electric power storage comprises a battery.

7. The vehicle according to claim 5, wherein:
the mechanical energy converter comprises a high voltage AC generator and an AC/DC converter.

8. The vehicle according to claim 7, wherein the mechanical energy converter further comprises:
a controller for monitoring the status or charge condition of the battery.

9. The vehicle according to claim 1, wherein:
the electric power storage and the mechanical energy converter of one of the two tilting units is also connected to the controller of the other tilting unit.

10. The vehicle according to claim 1, wherein:
the power transmitting medium is electricity or an electric current.

11. The vehicle according to claim 10, wherein:
the controller is configured to uncouple the battery from either of the control units and supply electricity to either of the two control units from the AC/DC converter and the generator.

12. The vehicle according to claims 1, further comprising:
a signaling element, whereby feedback on the condition of the vehicle is provided to a driver.

13. The vehicle according to at claim 1, wherein:
the control units, especially the electric circuit units, of the two tilting units are configured to communicate with each other, to assure the functionality of at least one of the two tilting units.

14. The vehicle according to claim 12 wherein:
the signaling element is coupled to at least one electric circuit unit to signal the driver of the vehicle concerning a malfunction of one of the tilting units.

15. The vehicle according to claim 1 further comprising:
a transducer coupled between the tilting units and the main body.

16. The vehicle according to claim 15, wherein:
a single transducer is coupled between the two tilting units and the main body.

17. The vehicle according to claim 15 wherein:
the transducer comprises a mechanical element.

18. The vehicle according to claim 15 wherein:
the transducer comprises a steering shaft.

19. The vehicle according to claim 15, wherein:
the transducer comprises a brake caliper.

20. The vehicle according to claim 1, further comprising:
a first mode switch to choose between a manual or an automatic tilting mode.

21. The vehicle according to claim 1, further comprising:
a second mode switch to select the acceleration or speed of the tilting unit tilting the vehicle.

22. The vehicle according to claim 21, wherein:
the second mode switch is configured to change the torque of the actuator.

23. The vehicle according claims 4, further comprising:
at least one sensor, selected from the group consisting of a current sensor, an accelerometer, and a position sensor, whereby data concerning the actual state of the vehicle to one of the control units is delivered.

24. The vehicle according to claim 23, wherein:
the at least on sensor is coupled to both control units.

25. The vehicle according to claim 4, wherein:
the control units are configured as an open loop control.

26. The vehicle according to claims 4, the control units are configured as a closed loop control.

27. The vehicle according to claim 4, wherein:
both control units are configured as an open loop control or a closed loop control.

28. The vehicle according to claim 1, further comprising:
a recharge unit configured to recharge the power provision unit.

29. A vehicle providing improved reliability during tilting while cornering comprising:
a main vehicle body having a longitudinal axis;
a transducer, said transducer providing a force sufficient to tilt said main body about the longitudinal axis of said main vehicle body;
a first tilting unit coupled to said transducer;
a second tilting unit coupled to said transducer; and
communication control means, coupled to said first tilting unit and said second tilting unit, for communicating between said first and second tilting units,
whereby should either said first or second tilting units malfunction tilting control is not lost.

30. A vehicle providing improved reliability during tilting while cornering as in claim 29 wherein each of said first and second tilting units comprises:
an electromotor;
a control unit coupled to said electromotor; and
a power supply providing power to said electromotor and said control unit.

31. A vehicle providing improved reliability during tilting while cornering comprising:
a main vehicle body having a longitudinal axis;
a transducer, said transducer providing a force sufficient to tilt said main body about the longitudinal axis of said main vehicle body;
a first tilting unit coupled to said transducer, said first tilting unit comprising a first electric motor, a first control unit coupled to the first electric motor, and a battery;
a second tilting unit coupled to said transducer, said second tilting unit comprising a second electric motor, a second control unit coupled to the second electric motor, and a generator, whereby the generator is capable of being driven by an engine of the vehicle; and
communication control means, coupled to said first tilting unit and said second tilting unit, for communicating between said first and second tilting units and controlling power distribution between the battery of said first tilting unit and the generator of said second tilting unit,
whereby should either said first or second tilting units malfunction tilting control is not lost.
